(19) United States
(12) Patent Application Publication
(10) Pub. No.: US 2024/0253723 A1
(43) Pub. Date: Aug. 1, 2024

(54) System For Attaching Accessories To A Snowmobile

(71) Applicant: Polaris Industries Inc., Medina, MN (US)

(72) Inventors: Benjamin T. EDWARDS, North Branch, MN (US); Dustin MERTENS, Roseau, MN (US); Michael A. HEDLUND, Roseau, MN (US); Cory HUOT, Little Canada, MN (US); Jeffrey A. EATON, Roseau, MN (US); Corey OMDAHL, Roseau, MN (US); Jeremy Allen HUGHES, Roseau, MN (US); Cameron D. FISHER, Plymouth, MN (US); Cory A. WIMPFHEIMER, Greenbush, MN (US); Barry A. JOHNSON, Roseau, MN (US); Derek THIBERT, Roseau, MN (US); David W. CHRISTIAN, Saint Francis, MN (US)

(21) Appl. No.: 18/411,557

(22) Filed: Jan. 12, 2024

Related U.S. Application Data
(60) Provisional application No. 63/441,485, filed on Jan. 27, 2023.

(51) Int. Cl. B62J 11/22; B62J 9/27; B62M 27/02

(52) U.S. Cl. CPC B62J 11/22; B62J 9/27; B62M 27/02; B62M 2027/028

(57) ABSTRACT

A snow flap has a first portion that may include a first material. The first portion also includes a second portion may include a second material, said first material stiffer than the second material. The portion also includes a joint formed between the first portion and the second portion.

### CROSS-REFERENCE TO RELATED APPLICATION

This application claims the benefit of U.S. Provisional Application No. 63/441,485, filed on Jan. 27, 2023. The entire disclosure of the above application is incorporated herein by reference.

### FIELD

The present disclosure relates to a system for attaching accessories to a snowmobile.

### BACKGROUND

This section provides background information related to the present disclosure, which is not necessarily prior art.

A snowmobile is a motorized vehicle designed for winter travel and recreation, for example. A snowmobile may operate on snow and ice, and does not require a road or trail. Some snowmobiles accommodate attachment of an accessory behind the operator's seat, such as a storage container. On some snowmobiles, it is desirable to have a passenger seat. One problem with implementing a passenger seat is that the storage area is reduced. Improving the passenger capacity while not reducing the storage capacity is important in many situations.

Another feature of a snowmobile is the snow flap. A snow flap is used to hold the snow in the tunnel area to allow cooling of the engine system.

Snow flaps, however, are sometimes not desirable in certain conditions. For example, removing the snow flap is common for mountain and utility snowmobiles.

One undesirable aspect of a snow flap is they tend to become stuck in the track or suspension when the snowmobile is reversed. Preventing the snow flap from becoming stuck and allowing the snow flap to be removed conveniently is desirable.

Snowmobiles have brake lights and taillights in the rear. The brake lights and taillights are red in color. Certain snowmobiles are used for work purposes and providing visibility during a working situation is desirable. Such functionality is desirable without removing the tail or brake light condition.

Accommodating attachments on a chassis is important. Certain vehicles may include pins for fixing receivers that have a means to connect the pins. However, in other situations, the pins interfere with the storage capacity of the snowmobile and prevent the full use of the storage area. Providing full access and full use of the storage area of the snowmobile is desirable.

### SUMMARY

This section provides a general summary of the disclosure and is not a comprehensive disclosure of its full scope or all of its features.

In one aspect of the present disclosure an improved system for attaching one or more accessories to a snowmobile is set forth.

One general aspect includes a snow flap having a first portion that may include a first material. The first portion also includes a second portion may include a second material, said first material stiffer than the second material. The portion also includes a joint formed between the first portion and the second portion.

Implementations may include one or more of the following features. The snow flap where the first portion is co-molded with the second portion to form the joint. The first portion extends rearward a predetermined angle from a of a tunnel. The predetermined angle is about 30 degrees. The second portion extends downward from the second edge in a first position. The second portion may be folded and retained to the second portion in a second position. The first portion may include a first integrally molded retainer tab on a first longitudinal edge and a second integrally molded retainer tab on a second longitudinal edge. A snowmobile may include: a chassis; a flap mount coupled to the chassis, said flap mount may include a laterally extending channel laterally receiving the snow flap therein. The laterally extending channel may include a c-channel. The lower portion of the c-channel extends rearward more than an upper portion of the c-channel. The first edge may include a retaining profile received within the laterally extending channel. The laterally extending channel may include a first oval profile and the retaining profile may include a second oval profile sized to be received within the first oval profile.

One general aspect includes a rear light assembly for a vehicle. The rear light assembly also includes an elongated housing may include a first portion at a first end, a second portion at a second end and a middle portion between the first end and the second end. The assembly also includes said first portion and the second portion may include red light sources. The assembly also includes said middle portion may include red light sources and white light sources. The assembly also includes a light controller activates the red light sources in the first portion, the second portion and the middle portion as a brake light and taillight in a first mode and, in a second mode, activates the white light sources of the middle portion to illuminate and deactivating the red light sources of the middle portion.

Implementations may include one or more of the following features. The rear light assembly where the light controller deactivates the white light sources in the middle portion in the first mode. The light controller may include activating the red light sources in the first portion and the second portion as brake and taillights in the second mode. The light controller activates the first mode or the second mode in response to a switch. The light controller activates the first mode or the second mode in response to a gear sensor. The light controller activates the first mode of the second mode in response to a speed signal from a speed sensor. The light controller activates the first mode of the second mode in response to a location signal from a location module or a key position signal from a key switch. The light controller may include a user interface and a control module. The light controller deactivates the white light sources in the second mode based on vehicle speed. The first portion, the second portion and the middle portion are disposed on a unitary printed circuit board.

One general aspect includes a locking pin assembly for an accessory. The locking pin assembly also includes a housing may include an upper portion a lower portion and a wall disposed between the upper portion and the lower portion, said upper portion having a volume thereunder. The assembly also includes a pair spaced-apart slots disposed in the upper portion; a latch pin may include a base portion and a pin portion, said base portion having a first position and a second position within the slot, where in the first position the pin portion is disposed outward from the upper portion and in the second position the base portion is received in the slot so that the pin portion is disposed downward into the volume. The assembly also includes a flexible finger coupled to the lower portion, said finger retaining the base portion in the slot in the first position and the second position.

Implementations may include one or more of the following features. The locking pin assembly where the finger is adjacent to the slot and deformable to be positioned below the slot. The slot is defined between an upper flange and a lower flange of the upper housing. The pin portion is rectangular in cross-section. The pin portion may include a knob disposed thereon. The flexible finger may include a first finger and a second finger, said first finger spaced apart from the first finger. The upper portion is formed into a rack platform.

One general aspect includes the snowmobile that includes a chassis; a primary seat for an operator of the snowmobile mounted to the chassis. The snowmobile also includes a storage rack mounted to the chassis; a passenger seat behind the primary seat. The snowmobile also includes said storage rack having a first slot therein for securing the passenger seat thereto.

Implementations may include one or more of the following features. The snowmobile may include a first accessory mounted to the chassis behind the primary seat and beneath the passenger seat where the first accessory may be mounted and removed without removing the passenger seat. The passenger seat has an arch thereunder, said arch sized to accommodate the first accessory. The arch is coupled to the first slot. The first slot is disposed on an upper surface of the storage rack and where the arch is coupled to the first slot on longitudinal slots. The snowmobile may include a second accessory in cooperation with the first accessory and mounted to the chassis behind the first accessory. The first accessory includes a first storage container, a first fuel tank, a first oil tank, a first chainsaw mount, a snowboard rack, an ice auger mount, a ski mount, or a gun scabbard. The second accessory includes a storage container, a secondary seat, a fuel tank, an oil tank, a chainsaw mount, a snowboard rack, an ice auger mount, a ski mount, or a gun scabbard. The first accessory is locked to first pin portions mounted to the chassis and the second accessory is locked to second pin portions mounted to the chassis. The first pin portions are reversibly locked to a rack platform of the chassis, and the second pin portions are reversibly locked to the rack platform of the chassis. The storage rack may include an upper rail may include the first slot on an upper surface. The upper rail may include an inner surface may include a second slot and an outer surface may include a third slot. The storage rack may include a lower rail having a second inner surface and a second outer surface, the upper rail spaced apart from the lower rail, said second inner surface may include a fourth slot and said second outer surface may include a fifth slot. The first slot, the second slot, the third slot, the fourth slot and the fifth slot may include t-slots. The snowmobile may include a first accessory holder coupled to the third slot and the fifth slot. The first accessory holder may include a first mount and a second mount for coupling to a second accessory holder. A first pair of fastener receivers on the first mount are aligned with the third and fifth slot, respectively, and where a second pair of fastener receivers on the second mount are aligned with the third and fifth slot, respectively. The snowmobile may include an accessory rack and the passenger seat being toollessly mounted to the storage rack.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a perspective view of an exemplary snowmobile in accordance with the present disclosure;

FIG. 1B is another perspective view of the snowmobile;

FIG. 1C is a front view of the snowmobile;

FIG. 1D is a rear view of the snowmobile;

FIG. 1E is a top view of the snowmobile;

FIG. 1F is an exploded view of the snowmobile;

FIG. 2A is a perspective view of a snow flap of the present disclosure.

FIG. 2B is a rear view of the snow flap of the present disclosure.

FIG. 2C is a side view of the mounting of the snow flap.

FIG. 2D is an exploded view of the snow flap.

FIG. 2E is an enlarged view of a portion of the first portion of the snow flap.

FIG. 2F is a tooling design for a snow flap.

FIG. 2G is a cross-sectional view of the mount for the snow flap.

FIG. 2H is an alternative cross-sectional view for a mount for a snow flap.

FIG. 2I is yet another alternative view of a mount for a snow flap with a snow flap mounted therein.

FIG. 2J is a side view of the tab for holding the snow flap in an unlocked position.

FIG. 2K is a side view of a snow flap having the tab in an unlocked position.

FIG. 2L is a side view of the snow flap in a folded position.

FIG. 3A is a perspective view of a multi-purpose light.

FIG. 3B is a cross-sectional view of the light assembly of FIG. 3A.

FIG. 3C is a block diagrammatic view of the light controller coupled to the light housing.

FIG. 3D is a detail block diagrammatic view of the light.

FIG. 3E is a flowchart of a method for operating the work light.

FIG. 4A is a perspective view of the rack platform having a plurality of locking pin assemblies therein.

FIG. 4B Is a perspective view of the rack platform having the latch pin removed.

FIG. 4C is a perspective view of a pin housing having the latch pin in an outward first position.

FIG. 4D is a perspective view of the pin housing having the latch pin 430 in an inward or stored position.

FIG. 4E is a front view of the pin housing of FIGS. 4A and 4B.

FIG. 5A is a perspective view of a rack having an accessor therein.

FIG. 5B is a rear perspective view of a rack having three accessories mount therein.

FIG. 5C is a side view of an accessory mounted beneath an arch of a seat.

FIG. 5D is an enlarged view of the upright members and the inside view of the arch mounting the passenger seat thereto.

FIG. 6A is a perspective view of the rack having a first and second accessory holder coupled thereto.

FIG. 6B is an enlarged view of the mounting of the first accessory holder 610A relative to a portion of the accessory holder 610B.

FIG. 6C is a side view of the vehicle having the first accessory holder 610A without a second accessory holder.

FIG. 6D is a side view corresponding to FIG. 6C with a tool, such as an axe therein.

FIG. 6E is a perspective view of an accessory holder in a partially opened position.

Corresponding reference numerals indicate corresponding parts throughout the several views of the drawings.

### DETAILED DESCRIPTION

Example embodiments will now be described more fully with reference to the accompanying drawings.

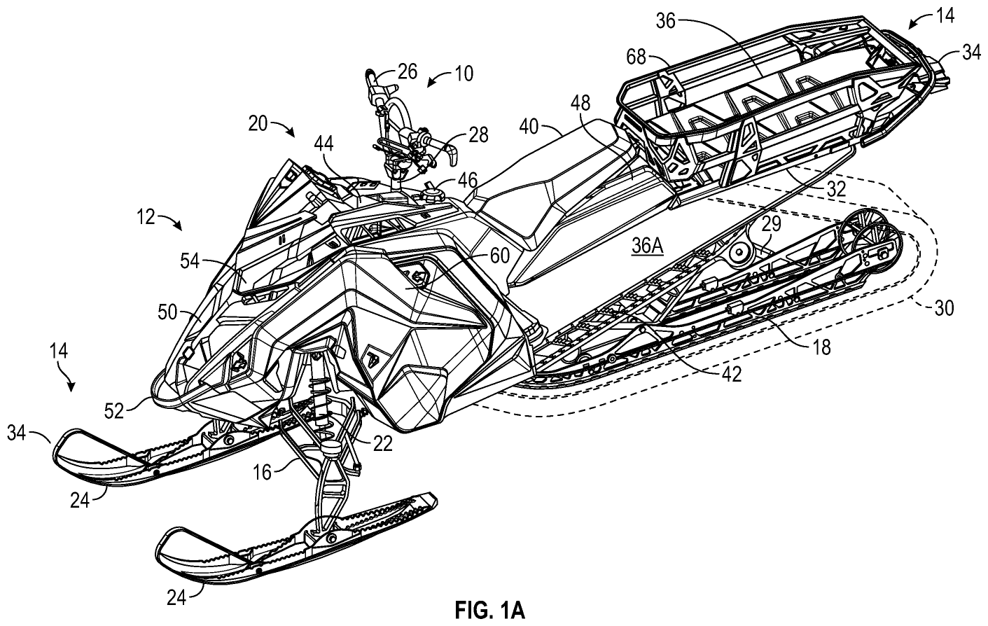

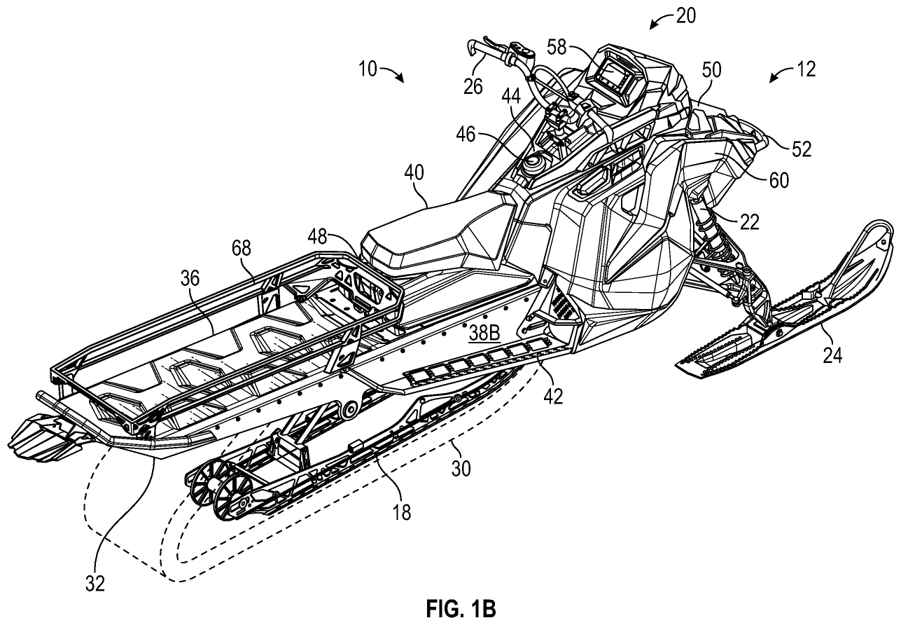

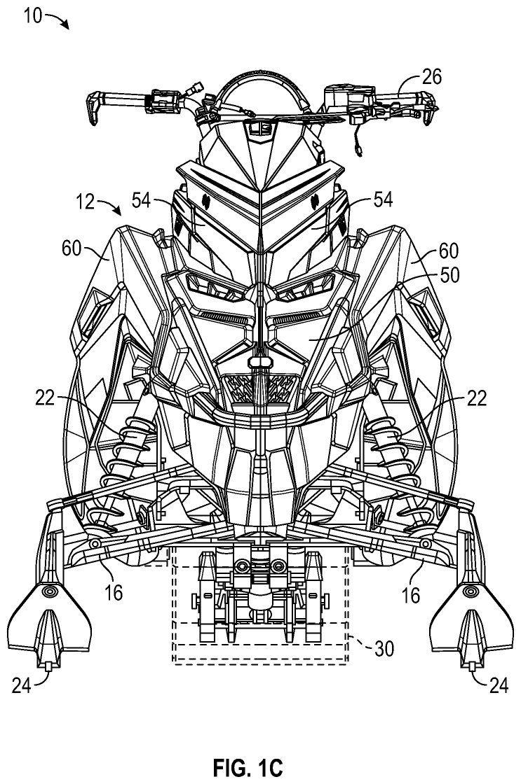

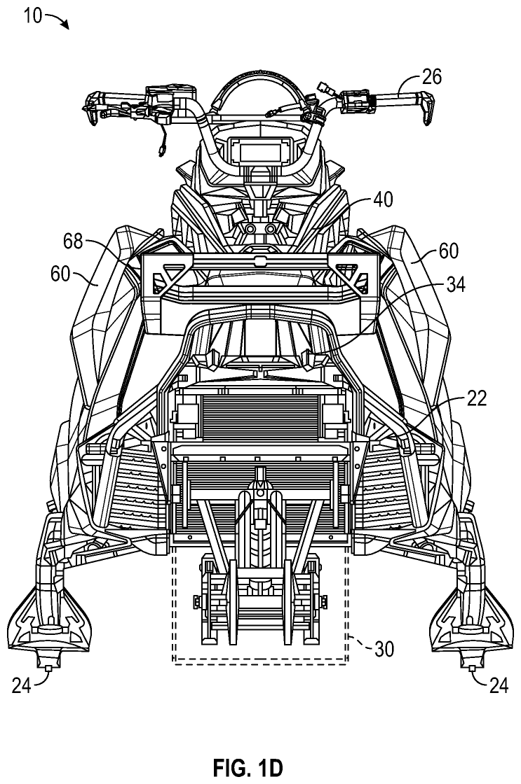

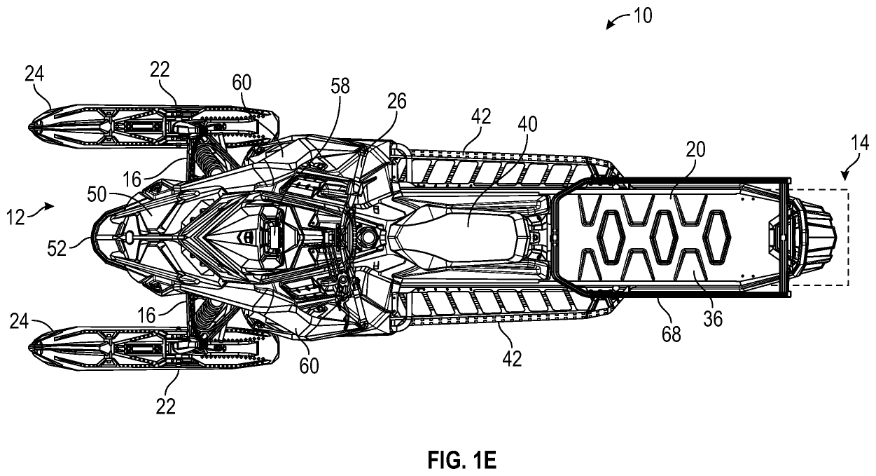

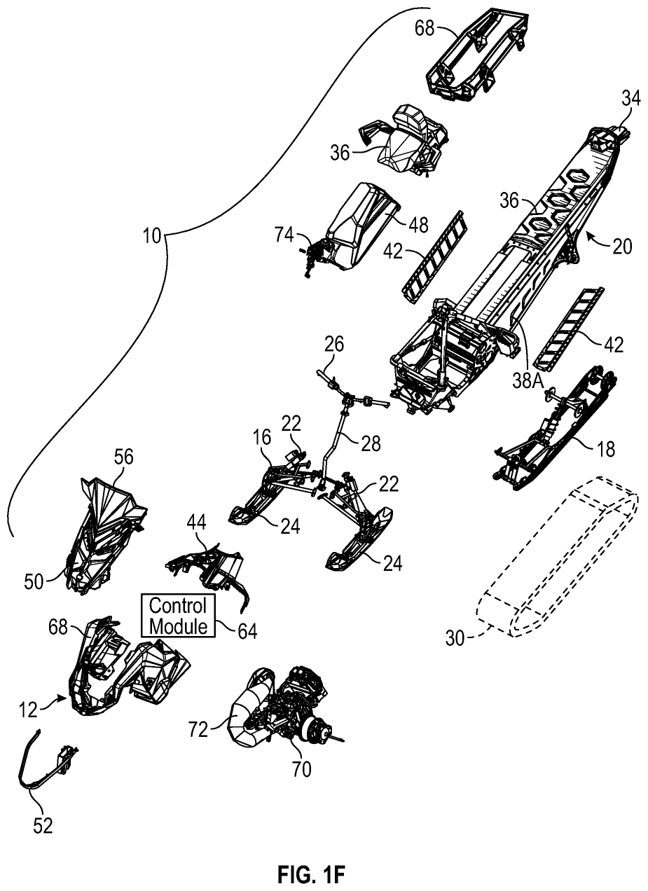

With initial reference to FIGS. 1A-1F, an exemplary vehicle in accordance with the present disclosure is illustrated. Although the vehicle is illustrated as a snowmobile 10, numerous aspects of the present disclosure may be included with any other suitable vehicle as well. The snowmobile 10 may be any suitable type of snowmobile, such as any suitable trail snowmobile, sport trail snowmobile, touring snowmobile, performance snowmobile, utility snowmobile (such as any snowmobile suitable for search and/or rescue, law enforcement, military operations, etc.), crossover snowmobile, mountain snowmobile, youth snowmobile, etc.

The snowmobile 10 generally includes a front end 12 and a rear end 14. At the front end 12 is a front suspension 16. At the rear end 14 is a rear suspension 18. The front suspension 16 and the rear suspension 18 support a chassis 20.

The front suspension 16 includes shock absorbers 22, each one of which is connected to a ski 24. The shock absorbers 22 may be any dampening device suitable for absorbing shock resulting from the skis 24 passing over uneven terrain. The skis 24 are steered in part by a suitable steering device, such as handlebars 26.

Coupled to the rear suspension 18 is a belt or track 30, which is an endless or continuous belt or track 30. Rotation of the track 30 propels the snowmobile 10. The track 30 is circulated through a tunnel 32 defined at least in part by the chassis 20. The tunnel 32 may be tapered at the rear end 14. Mounted at the rear end 14 is a flap 34, which blocks snow and other debris from being “kicked-up” by the track 30.

Mounted to the chassis 20 and atop the tunnel 32 is a primary or operator's seat 40 for the operator of the snowmobile 10. On both sides of the chassis 20 or tunnel 32 are footrests 42, upon which the operator may rest his or her feet when seated on the seat 40. The seat 40 is positioned to allow the driver to grasp the handlebars 26 for steering the snowmobile 10. The handlebars 26 are mounted to a steering rod 28, which protrudes out from within the center console 44. At the center console 44 is a fuel cap 46 of a fuel tank 48. Any suitable accessory 38 may be mounted to the chassis 20 behind the seat 40 and under the seat 36. Suitable accessories include, but are not limited to, one or more of the following: a storage container, a secondary seat, a fuel tank, an oil tank, a chainsaw mount, a snowboard rack, an ice auger mount, a ski mount, a gun scabbard, etc.

At the front end 12 of the snowmobile 10 is a hood assembly 50, which is mounted on top of a nose pan 51. Mounted to the hood assembly 50 and protruding from a forward most end thereof is a front bumper 52. The hood assembly 50 houses headlights 54. An optional windshield 56 is connected to an uppermost portion of the hood assembly 50. Associated with the hood assembly 50 is a display 58 viewable by the operator when seated on the seat 40. Mounted to opposite sides of the hood assembly are body panels 60, which are advantageously interchangeable.

A light assembly 62 is also illustrated near the rear end 14 of the snowmobile 10. The light assembly 62 may act as a brake light assembly, a tail lamp assembly and a work light as is described in more detail below.

A rack platform may be used to secure a storage rack 68 to the chassis 20. The rack platform 66 and the storage rack 68

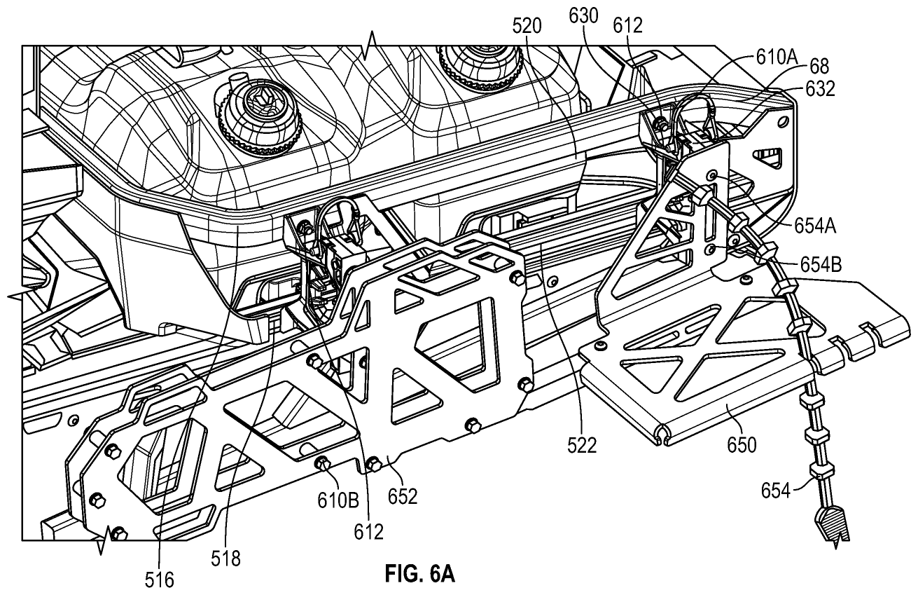

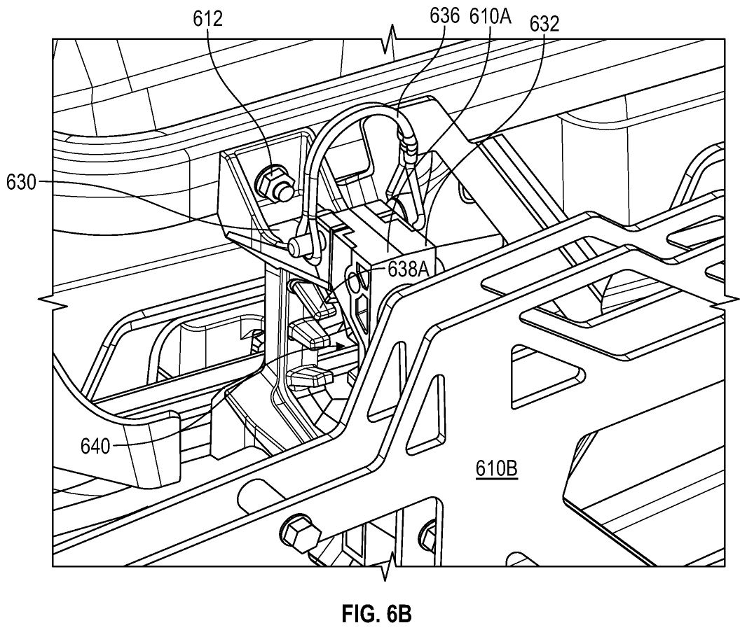

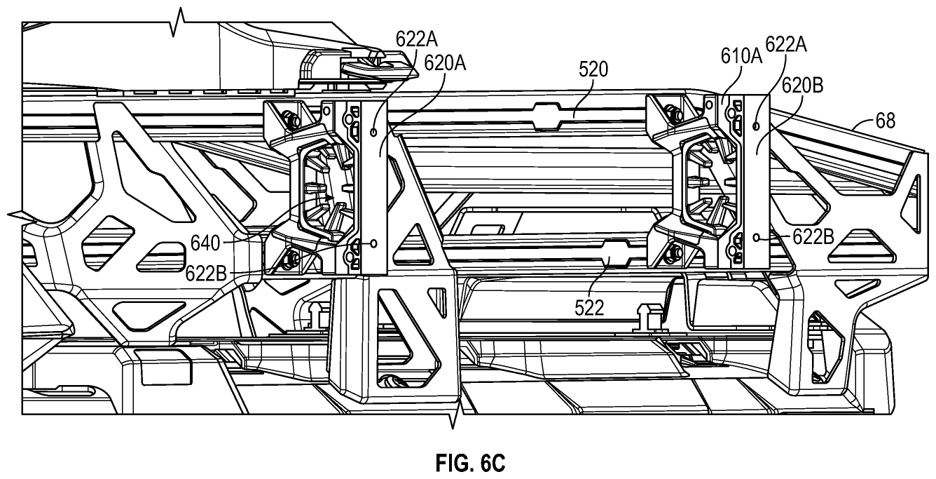

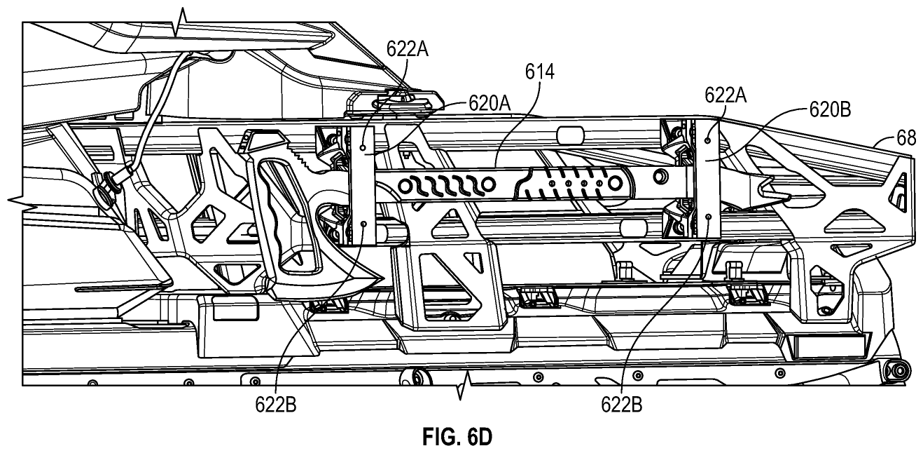

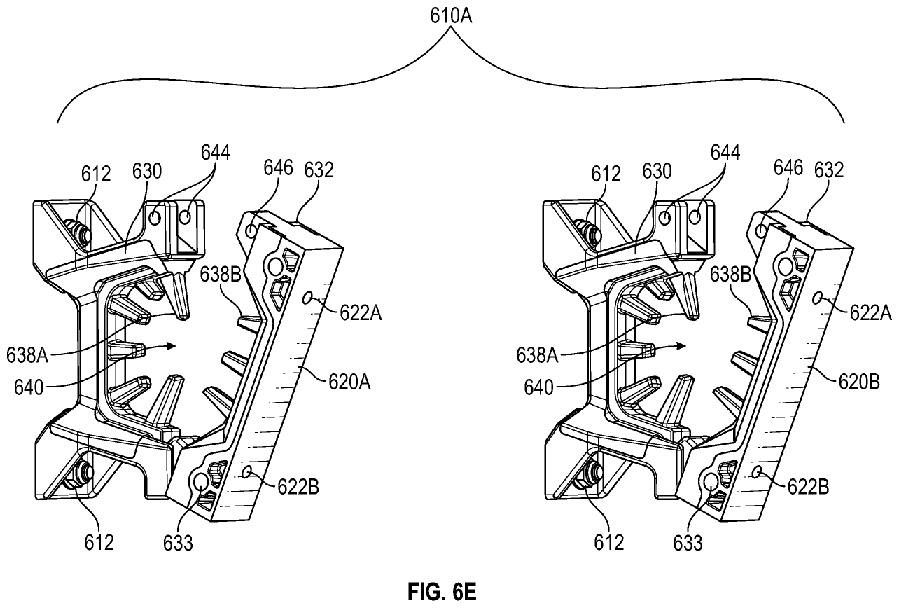

With particular reference to FIG. 6, the snowmobile 10 further includes an engine assembly 70. The engine assembly 70 generates power for driving the track 30. The engine assembly 70 may include any suitable engine, such as a two-stroke engine, a four-stroke engine (with or without a turbocharger), an 850 cc engine, etc. Coupled to the engine assembly 70 is any suitable exhaust assembly 72. Oil for the engine assembly 70 is stored in an oil tank assembly 74, which may be arranged proximate to the seat 40.

The snowmobile 10 further includes any suitable control module 64. The control module 64 may be arranged at any suitable location, such as within the hood assembly 50 or beneath the center console 44. More specifically, the control module 64 may be included with the display 58 or a control assembly mounted to the handlebars 26.

The term “control module” may be replaced with the term “circuit.” The term “control module” may refer to, be part of, or include processor hardware (shared, dedicated, or group) that executes code and memory hardware (shared, dedicated, or group) that stores code executed by the processor hardware. The code is configured to provide the features of the control module described herein. The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

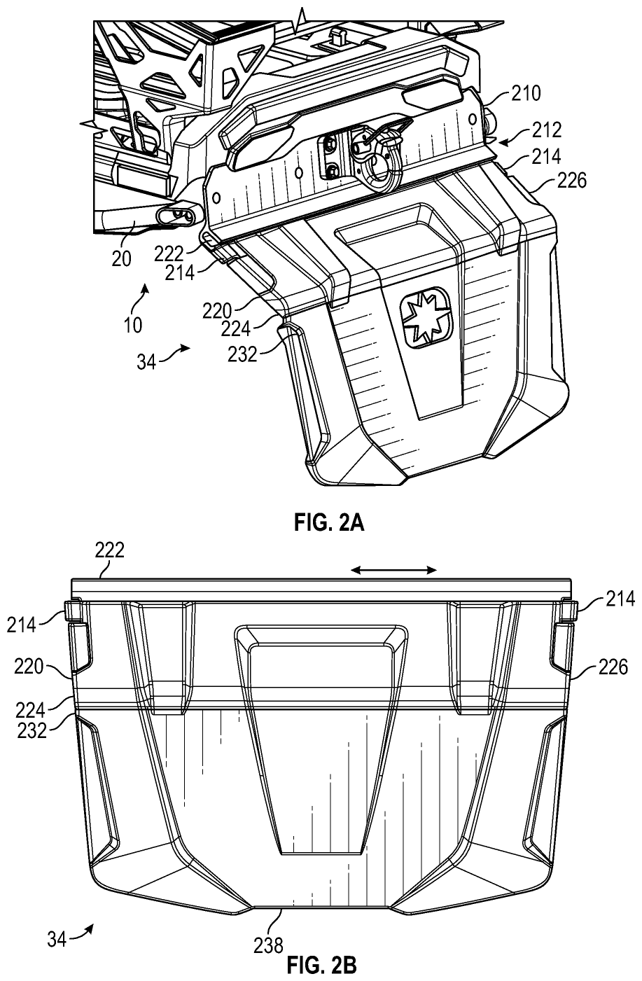

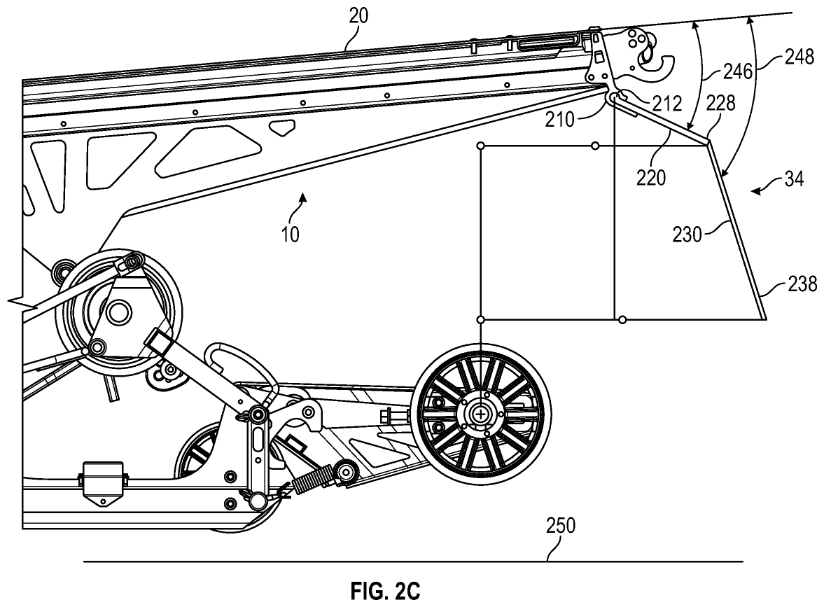

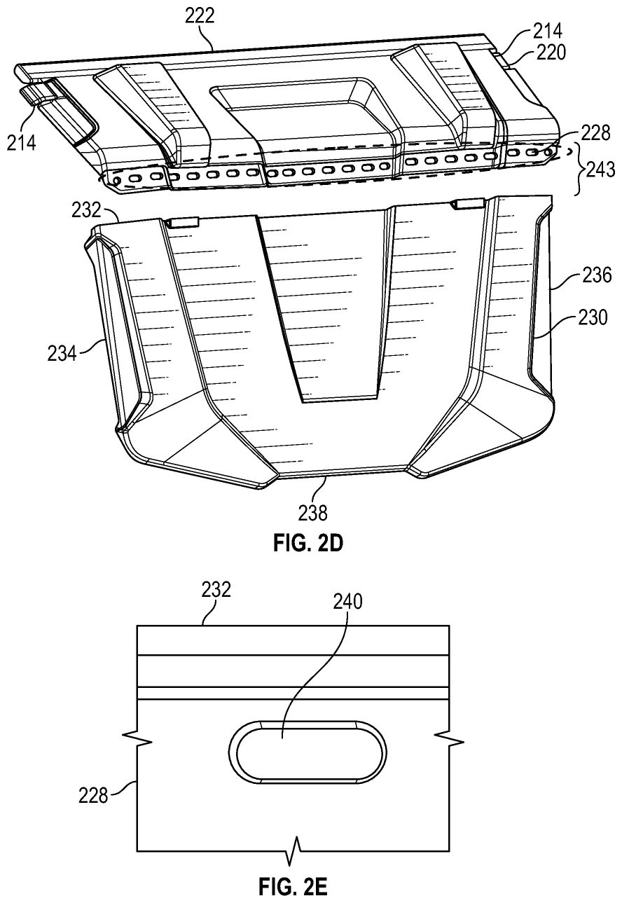

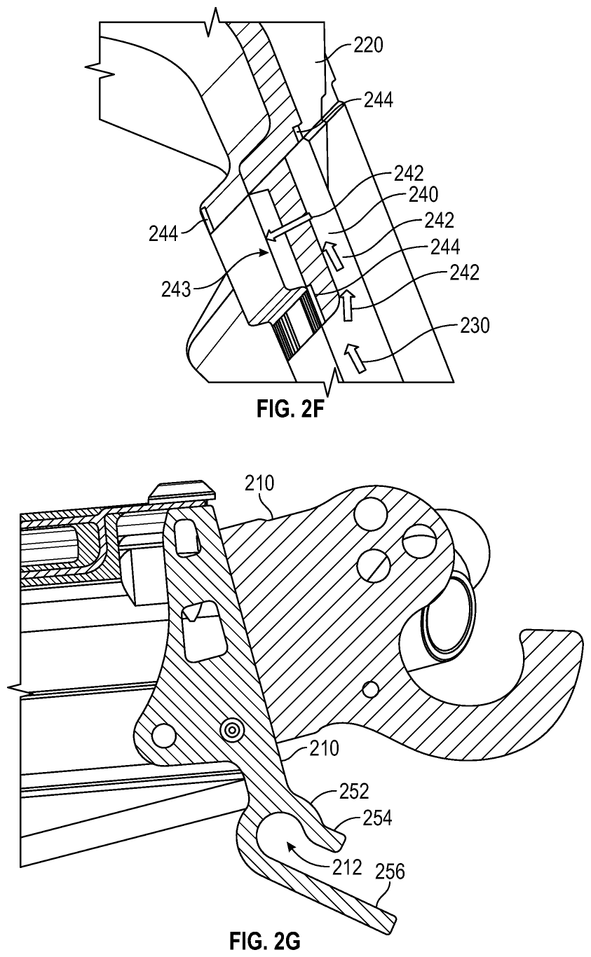

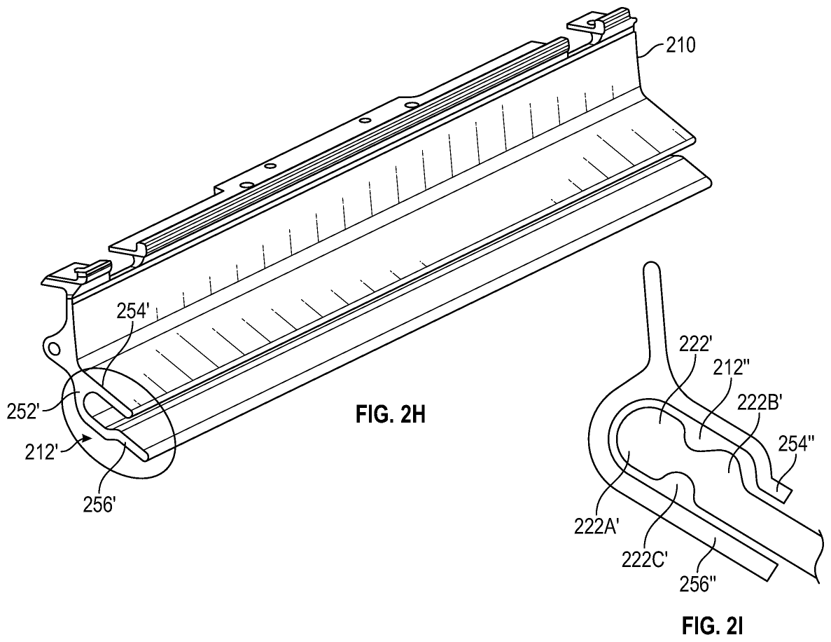

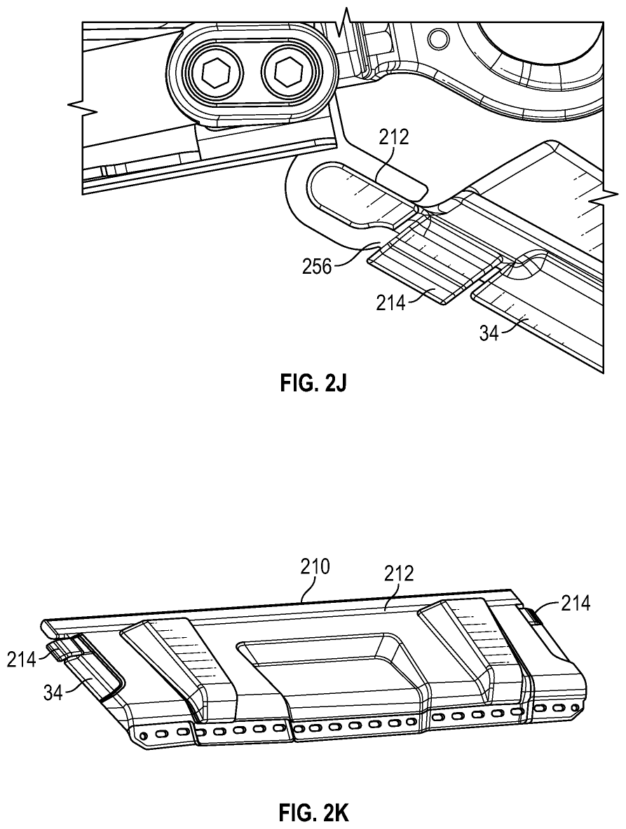

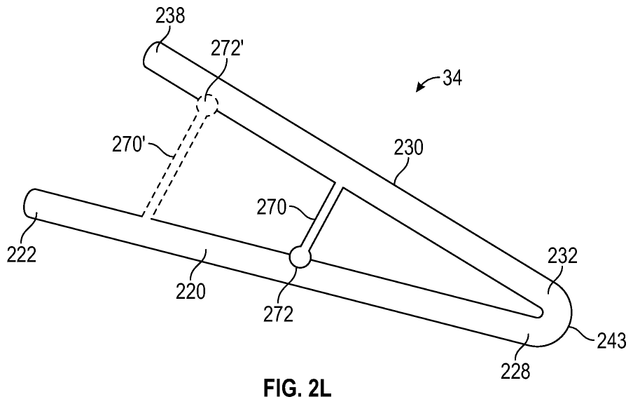

Referring now to FIGS. 2A-2C, one example of an improved flap is set forth. In this example, the flap 34 is coupled to a mount 210 that is mounted to the chassis 20 of the snowmobile 10. In this example, the mount 210 has a laterally extending channel 212 into which the snow flap 34 is slidably and removably coupled. In general, the laterally extending channels set forth herein are generally C-shaped. Details of the lateral extending channel 212 are provided below. Tabs 214 are formed on the outer side edges of the flap 34 to retain the snow flap 34 in the laterally extending channel 212 as described in further detail below. In general, the snow flap 34 has first portion 220 that has a first edge 222 that is used for mounting to the snowmobile 10. The first edge 222 may be oval in profile and sized to fit into the oval profile of the laterally extending channel 212. The first portion 220 may be made of thermal plastic elastomer (TPE). The thermal plastic elastomer of the first portion may be relatively stiff compared to the second portion 230 described below. Different types or additives in the TPE may change the stiffness making one portion stiffer than the other.

The first portion 220 includes the first longitudinal edge 224 and a second longitudinal edge 226. The longitudinal edges 224, 226 comprise the tabs 214 that may be integrally molded therewith. Movement of the tabs into different positions allow the tabs to lock the snow flap into the laterally extending channel 212 and unlock the flap 34 so that the snow flap 34 may be removed from the lateral extending channel 212 as illustrated in FIGS. 2J and 2K

A second laterally extending edge 224 of the first portion 220 has a retaining profile that is used for securing the second portion 230 of the flap thereto. The second portion 230 of the snow flap 34 may also be formed of a thermoplastic elastomer having different characteristics than the thermoplastic elastomer used for the first portion 220. That is, the thermoplastic elastomer in the second portion may be relatively soft or rubber like to create a flexible second portion 230. The second portion 230 has a first laterally extending edge 232 that may be at least partially rotatably coupled to the second lateral edge 228 of the first portion 220. As is best illustrated in FIGS. 2D and 2E, openings 240 in the second laterally extending edge 228 may be used in the co-molding process of the formation of the first portion 220 and the second portion 230.

The second laterally extending edge 238 is disposed away from the chassis 20 of the snowmobile 10.

Referring now also to FIG. 2F, the first portion 220 is illustrated relative to second portion 230. In this example, when the first portion 220 and the second portion 230 are co-molded, the arrows 242 illustrate a preferred material flow direction. The co-molded first portion 220 and the second portion 230 from a joint 243 therebetween. During the molding process, the molds may include shutoffs illustrated at 244. The shutoffs 244 allow the material to flow in a suitable direction so that an appropriate bond is formed so that the second portion 230 is retained on the first portion 220.

Referring now specifically to FIG. 2C, the side view of the first portion 220 relative to the second portion 230 when the snow flap 34 is mounted to the snowmobile 10 is illustrated. In this example, an angle 246 is formed between the top of the chassis 20 and the first portion 220. In the present example, the angle 246 is a predetermined angle of about 30°. This allows the second lateral edge 228 of the first portion 220 to be maintained rearward of the end of the snowmobile 10 so that as the second portion 230 hangs at an angle 248 that is substantially greater than the first angle 246 is formed relative to the chassis of the vehicle. By this, the second lateral edge 238 of the second portion is rearward and downward from the chassis 20.

The second edge 238 extends, in this example, about 12 inches above the ground 250 on which the snowmobile 10 is riding. Of course, different snowmobiles may have different distances.

Referring now to FIGS. 2G, one example of the laterally extending channel 212 is illustrated. In this example, the mount 210 has a retaining profile having a generally circular wall 252 that extends from the mount 210 in a clockwise direction. An extension 254 extends in the direct of the connected first portion when the first portion 220 is laterally inserted into the laterally extending channel 212. A second extension 256 extends from the lower portion of the circular wall 252 and extends parallel to the first extension 254. The second extension 256 extends a greater distance rearward on the vehicle than the first extension 254. This allows the first portion 220 to be maintained in an outward direction illustrated best in FIG. 2C.

Referring now to FIG. 2H, an alternative cross-section of the laterally extending channel 212′ is illustrated. In this example, the first extension 254′ extends tangentially with the circular wall 252′, the second extending wall 256′ extends non-tangentially from the circular wall 252. Further, the lateral extending channel 212 is more elongated than that illustrated in FIG. 2G.

Referring now to FIG. 2I, another example of a laterally extending channel 212″. In this example, the first extension 254″ extends less than the second extension 256″ to form an elongated laterally extending channel 212″. In this example, the first laterally extending edge 222′ has a retaining profile having a first thickness portion 222A′ and a second thickness portion 222B′ separated by a narrow portion 222C′. The cross section of the laterally extending channel 212″ is generally oval in shape and sized to receive the edge 222′ or 222 that may also be oval in profile.

Referring now to FIGS. 2J and 2K, the tabs 214 are illustrated in an locked portion in FIG. 2J and a unlocked position in FIG. 2K. The tabs 214 prevent lateral movement of the flap 34. One of the tabs 214 are rotated into the position in FIG. 2K so that lateral movement of the flap 34 and the first laterally extending edge 222 may be moved lateral from within the channel 212 of the mount 210.

Referring now to FIG. 2l, rather than removing the snow flap 34, the second portion 230 may be folded around onto the first portion 220. A retainer 270 may be retained in a recess 272 of the first portion 220. The retainer may be a knob or spike or a separate fastener. However, it is preferable that the retainer 270 be integrally molded with the second portion 230. Alternatively, a second retainer 270′ is illustrated extending from the first portion 220 into a recess 272′ of the second portion 230.

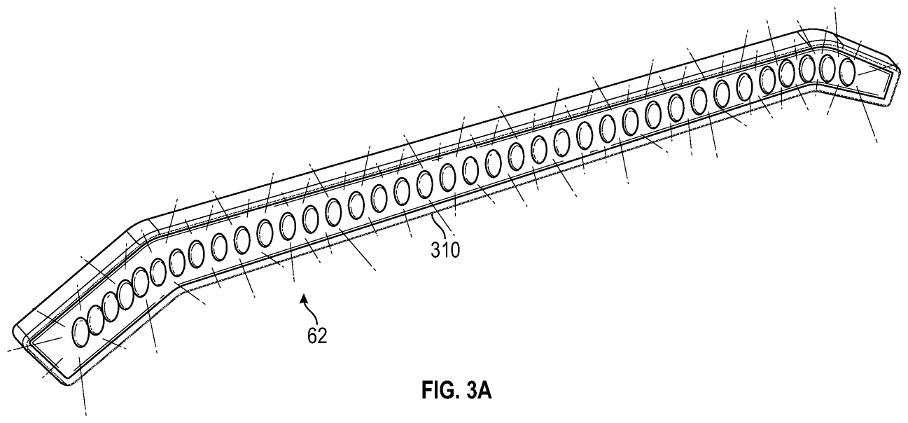

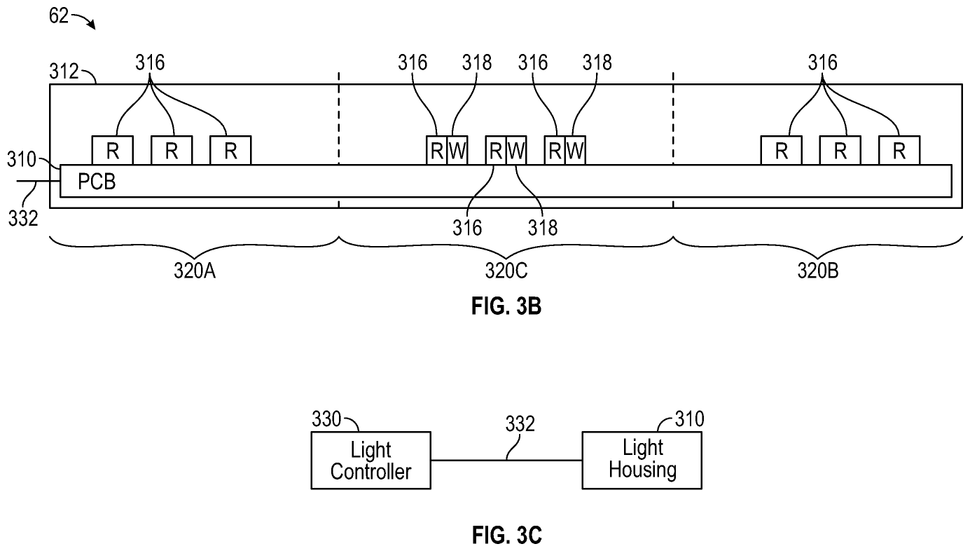

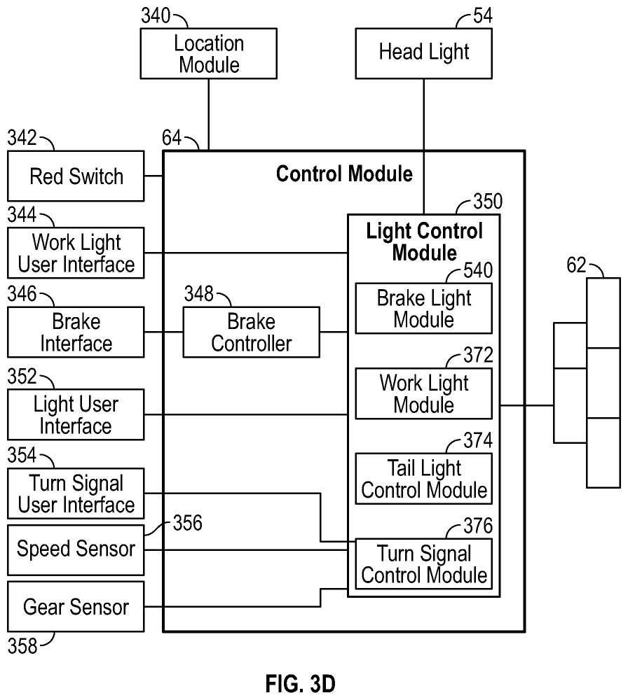

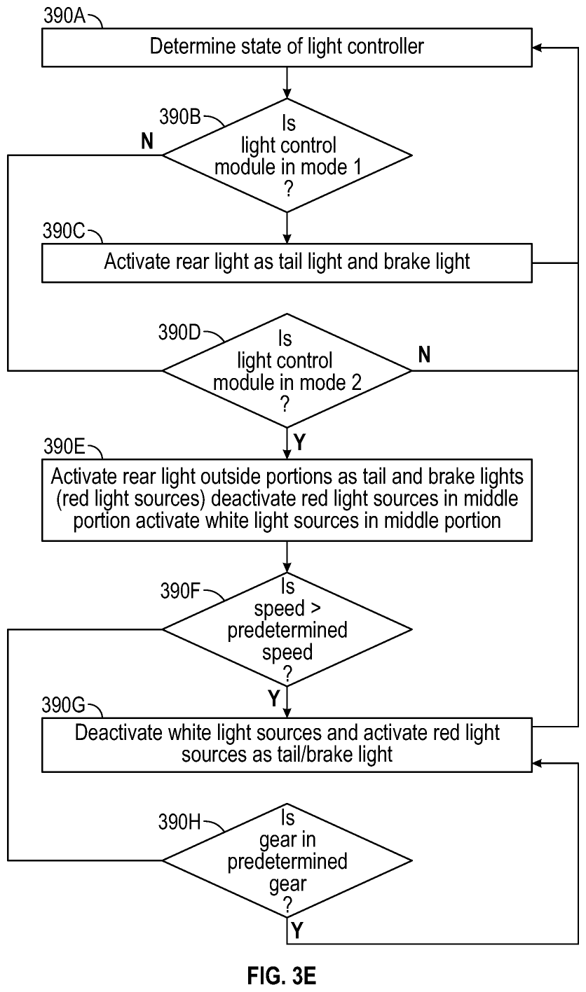

Referring now to FIGS. 3A and 3B, the rear light assembly 62 is illustrated in further detail. The light assembly 62 may comprise a housing 310 that has lens 312 coupled thereto. The lens 312 may be a solid lens (continuously formed) with no optical characteristics or may be provided with different types of optical characteristics to spread or diffuse the light from the light sources coupled to the housing. The housing 310 has a printed circuit board (PCB) 314 disposed therein. The printed circuit board 314 has a plurality of light sources disposed thereon and may be unitary in structure. The light sources in this example have different colors. In this example, red light sources 316 and white light sources 318 are used. The light assembly 62 has three portions, a first portion 320A on one end of the light assembly 62, a second portion 320B on a second end of the light assembly 62 and a middle portion 320C between the first portion 320A and the second portion 320B. The red light sources 316, in this example, are provided in the first portion 320A, the second portion 320B and the third portion 320C. The white light sources are provided in this example only in the middle portion 320C.

The operation of the red light sources is as follows. The red light sources may act as a taillight. That is, when the vehicle is on and running, the red light sources may be illuminated at a first intensity. When the brakes are applied to the vehicle, the intensity may increase to a second intensity higher than the first intensity. This may apply to all of the red light sources 316 through all of the portions 320A-320C. However, during a period where rearward illumination may be required, such as a work light type environment, the red light sources 316 may be deactivated and the white light sources 318 activated in the middle portion. This may allow the first portion 320A and the second portion 320B to continue to act as tail or brake lights as needed. Using the white lights, the rear of the vehicle may be illuminated to perform a work task behind the snowmobile 10. Of course, the light assembly may also be coupled to other types of vehicles such as a utility vehicle.

Referring now to FIG. 3C, the operation of the light sources 316, 318 may be controlled by a light controller 330. The light controller 330 may be a simple type of device to control the light source 316, 318 such as a switch. Other types of light controllers 330 may include push buttons, touch screens, dials and knobs. Further, the light controller 330 may be microprocessor based and provide various types of functions. The light controller 330 is coupled to the light housing 310 by wires 332. The wires 332 may be a single wire or a plurality of wires for various types of controls for the various types of light sources.

Referring now to FIG. 3D, as mentioned above, the light controller may be a part of the control module 64 described above. The control module 64 may be a microprocessor-based control module. Various inputs are provided to the control module 64 from different systems within the vehicle. For example, a location module 340 may provide a location signal to the control module 64 corresponding to the geographical coordinates of the vehicle. The location module 340 may for example, be a global positioning system receiver.

A key switch 342 may also provide an input to the control module. The key switch 342 may provide a key signal to the control module corresponding to the position of a key. In many automotive vehicles, the key switch 342 may have an on position, an accessory position and a start position. The key switch 342 may also be a push button key switch indicating the vehicle is on and running.

The control module 64 may also have an input from a work light user interface 344. The work light user interface 344 may be a switch, push button dial or other type of screen display or the like providing a work light on signal to the control module 364 which ultimately turns the work light on or off. A brake interface 346 provides a brake signal to the brake controller 348. The brake interface 346 may for example, be a hand brake or a foot brake depending upon the type of vehicle. The brake controller 348 controls the brakes accordingly. However, the brake controller 348 may also be coupled to a light control module 350 that has various modules therein.

The control module 64 may also have a light user interface 352. The light user interface may be used to turn on and off the headlights. Likewise, when the light user interface turns the headlights on, the taillights or red light sources 316 may act as a taillight and a lower intensity than when the brake lights are on.

Depending on the type of vehicle, the control module 64 may also include a turn signal interface 354. The turn signal interface may be a stalk or switch used for indicating which direction the vehicle is turning. The turn signal user interface 354 may ultimately allow some of the red light sources 316 to flash.

A speed sensor 356 may be coupled to the control module 64. The speed sensor 356 may provide a vehicle speed to the light control module 350.

A gear sensor 358 may provide a gear signal to the light control module. That is, based upon the gear, a signal is created and communicated to the light control module.

Ultimately, the control module 64 is used to control one or more headlights 54.

The light control module 350 may also be used to control the light assembly 62 in response to various inputs as described in further detail below.

The control module 64 may have a specific light control module 350 therein. The light control module 350 may include modules for controlling the different types of illumination desired. For example, a brake light module 370 may be used to control the brake lights. A work light module 372 may be used to control a work light based upon various conditions including a user interface. However, the work light module 372 may also be used to activate or deactivate red light sources 316 or white light sources 318 in response to the conditions. For example, the work light module 372 may turn off the work light in response to a specific gear being selected as sensed by the gear sensor 358. Likewise, when the speed of the vehicle increases above a speed threshold, as indicated by the speed signal from the speed sensor 356, the work light module may turn off the white light sources 318 in response to the speed signal. A light user interface 352, such as a switch or a touch screen display may be used to initially turn on the work light module in response to various conditions being present such as the speed being below a predetermined speed as indicated by the speed sensor 356, the gear sensor indicates the vehicle is parked and the like. The key switch 342 may also be condition for the work light module activating or deactivating the white light sources 318. For example, the key switch 342 may indicate an on position in order for the work light module 372 to turn on the work light 318.

A taillight control module 374 is used to control the taillights of the vehicle in a tail light mode. The taillight mode corresponds to a low intensity illumination that is less than intensity provided by the brake light module for the red light sources.

A turn signal control module 376 may be used on a vehicle when turn signals are to be used. This may for example, be provided in a four wheel utility vehicle. The turn signal control module 376 receives a signal from the turn signal user interface to activate the turn signals in the proper direction as desired by the vehicle operator.

Referring now to FIG. 3E, a method of operating the control module 64 is set forth. In step 390A, the state of the light controller is determined. The state of the light controller may be determined by the light control module and the inputs thereto. For example, the light user interface such as switches, dials or buttons may be used to generate a signal indicative of what the operator desires. The light control module 350 may operate the work light module 372 in various modes. The light control module may have a first mode. When the control module is in the first mode in step 390B, the control module 64 activates the rear light as taillight and brake light in step 390C. When the light control module is not in the first mode after step 390B, step 390D determines whether the light control module is in a second mode in step 390D. In step 390D, when the light control module is in the second mode, step 390E is used by the control module 64 to activate the rear light outside portions as a tail and brake light. That is, the red light sources are activated to be operated as the tail and brake lights while the red light sources in the middle portion are deactivated. In step 390E, the white taillight sources are activated in the middle portion. This corresponds to the vehicle operators desired action. However, when various other conditions are present, the work light may be deactivated. That is, the white light sources may deactivate based upon various conditions. In step 390F, when the speed is greater than a predetermined speed, the white lights are deactivated in step 390G. That is, the white light sources are deactivated and the red light sources are activated in the middle portion.

Referring back to step 390F, when the speed is not greater than a predetermined speed, the gear is checked. When the gear is in a predetermined gear in step 390H, step 390G is again activated.

After step 390C, step 390D when the light control module is not in the second mode and after step 390G, the system repeats in step 390A.

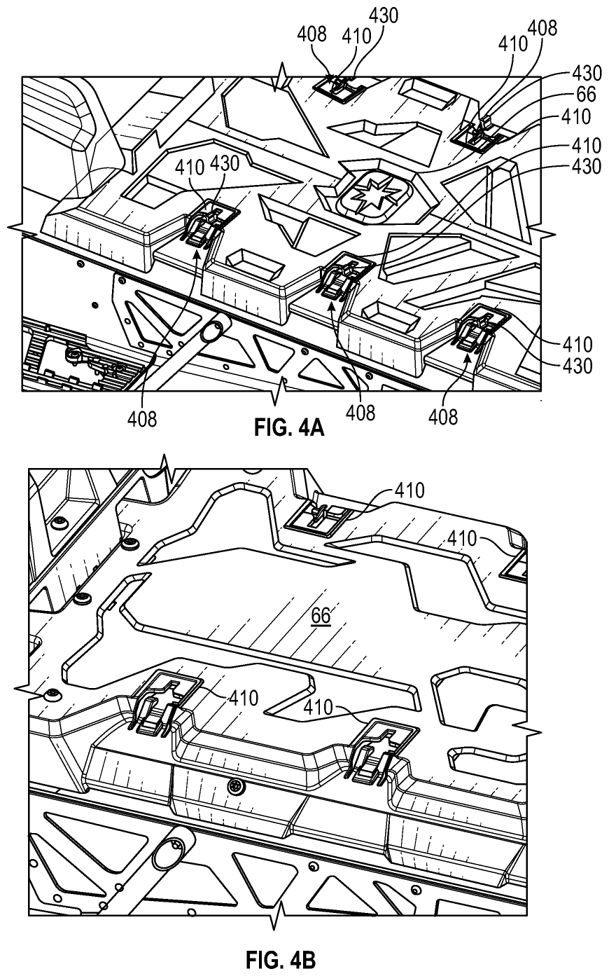

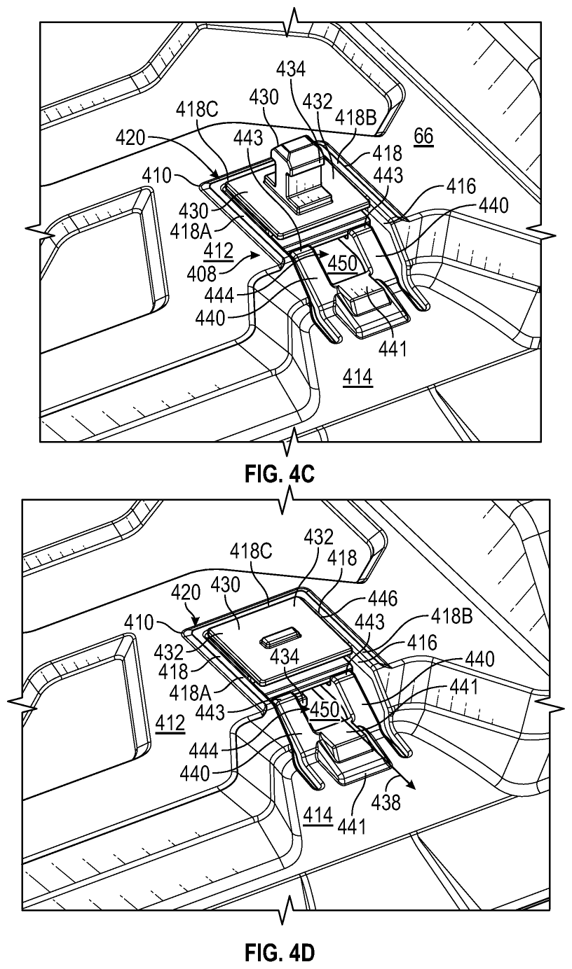

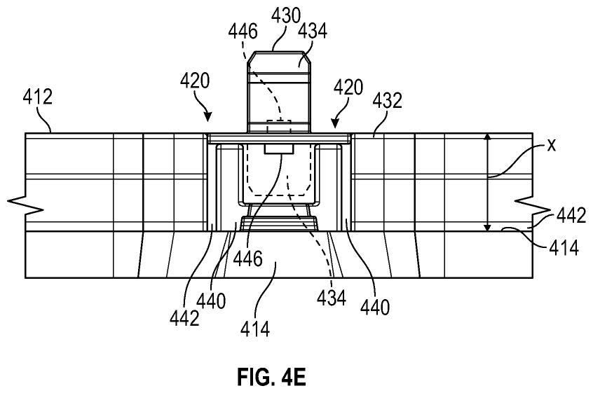

Referring now to FIGS. 4A-4E, details of the cargo or rack platform 66 are set forth. The rack platform is coupled to the chassis. One or more positions of the rack platform 66 form a locking pin assembly 408 comprising a pin housing 410. In the present example, six pin housings 410 are formed in the rack platform 66, five of which are shown in FIG. 4A. Although the pin housings 410 may be formed integrally with the rack platform, the pin housings 410 may be formed separately and mounted to the rack platform 66 or another part of the vehicle such as the chassis 20. FIG. 4B shows the receiver 420 without a latch pin 430 therein.

The rack 66 has an upper portion 412 spaced apart from a lower portion 414. The upper portion 412 and the lower portion 414 may be spaced apart by a distance X.

The upper portion 412 has a plurality of slots 416 disposed therein. The slots 416 in this example, are recesses from the upper surface of the upper portion 412. An upper flange 418 extends from the upper portion 412 over at least a portion of the slots 416 to form a receiver 420. The bottom of the slots 416 may be defined by a lower flange 419. The receiver 420 is used to form a latch pin 430. The latch pin 430 comprises a base 432 that is received within the receiver 420 between the slot 416 and the flange 418. The base 432 has a width to fit from slot to slot within the receiver 420.

It should be also noted that the flange 418 may be formed of three flange portions 418A, 418B and 418C. Flange portions 418A and 418B extend in a direction above the slots 416. The flange portion 418C extends between the flange portions 418A and 418B. The flange portions 418A-418C, in combination, help retain the base portion 432 within the slots 416.

The base 432 has a pin portion 434. The base portion 432 and the pin portion 434 may be integrally molded. The base portion 432 is removably received within the receiver 420 so that the pin portion 434 may be placed in an upward position as illustrated in FIG. 4C or a downward position as illustrated in FIG. 4D. To secure the base portion 432 within the slot, a pair of flexible fingers 440 are illustrated. A push button 441 extends between the fingers 440 to facilitate movement of the fingers 440 in the downward direction. The flexible and deformable fingers 440 may be pushed into a downward position using the push button 441 so that the base portion 432 may be slid from the slots 416 in an outward direction as illustrated by the arrow 438. The fingers 440 in the at rest position extend adjacent to the base portion 432 at least partially. The edge 443 of each finger 440 rests adjacent to the base portion 432 to prevent movement in the direction illustrated by the arrow 438. The fingers 440 may be integrally formed with the upper portion 412 and the lower portion 414. Slots 442 may be formed on the outer portions of the fingers 440. A central slot 444 that is disposed between the fingers 440 is wide enough to accommodate the width of the pin portion 434 when it is received within the receiver 420 in the downward position as illustrated in FIG. 4D. The pin housing 410 and at least the area of the fingers 440 are formed from a material that allows the fingers to flex when pressure is put in a downward direction so that the base portion 432 of the latch pin 430 may be released.

A grip 446 may be formed on the opposite side of the base portion 432 from the pin portion 434. The grip 446 allows the user to more firmly grip the latch pin 430 to reverse the latch pin 430.

In operation, the latch pin 430 may be positioned in an upright or outward position. To place the pin portion 434 in a downward direction, the finger or fingers 440 are depressed or deformed by pushing the push button 441 (or the finger 440 themselves) so that the edges 443 of the fingers 440 move downward to allow clearance so that the base portion 432 may be slid in an outward direction indicated by arrow 438 and removed from the slots 416. The latch pin 430 may be inverted and reversibly mounted so that the pin portion 434 is in a downward direction and is received within the space or volume 450 beneath the upper portion 412. The base portion 432 is pressed in a direction opposite the direction 438 and the fingers 440 are pressed inward until the base portion 436 is received between the slot 416 and the flange 418 entirely. The fingers 440, when pressure is released, are moved to an upward position.

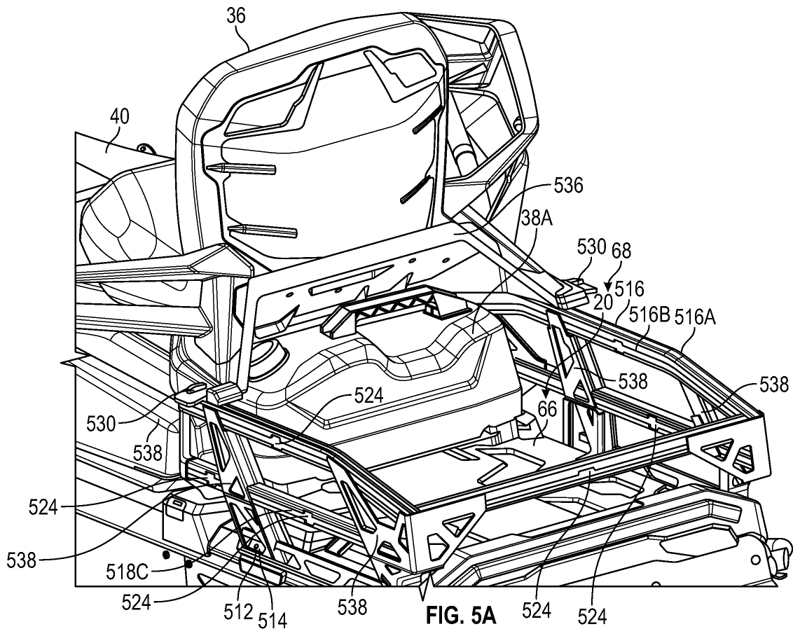

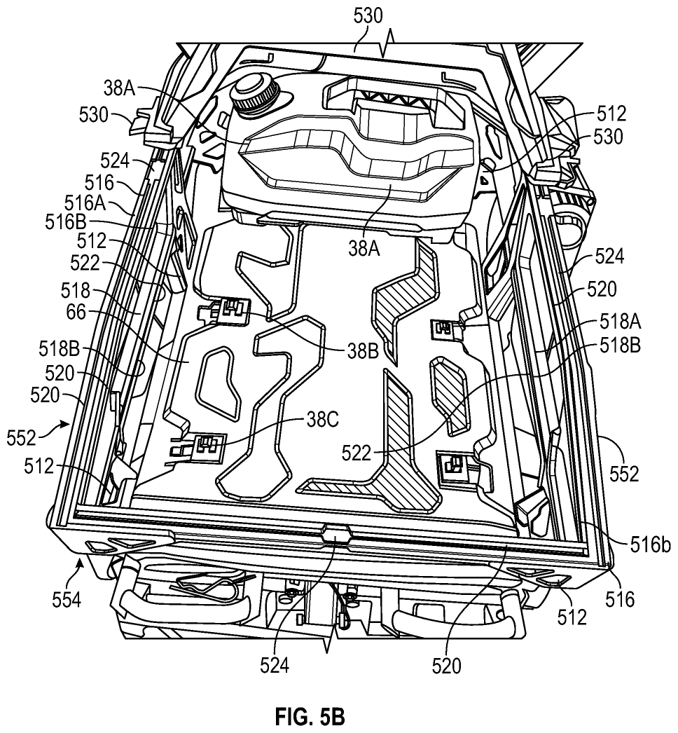

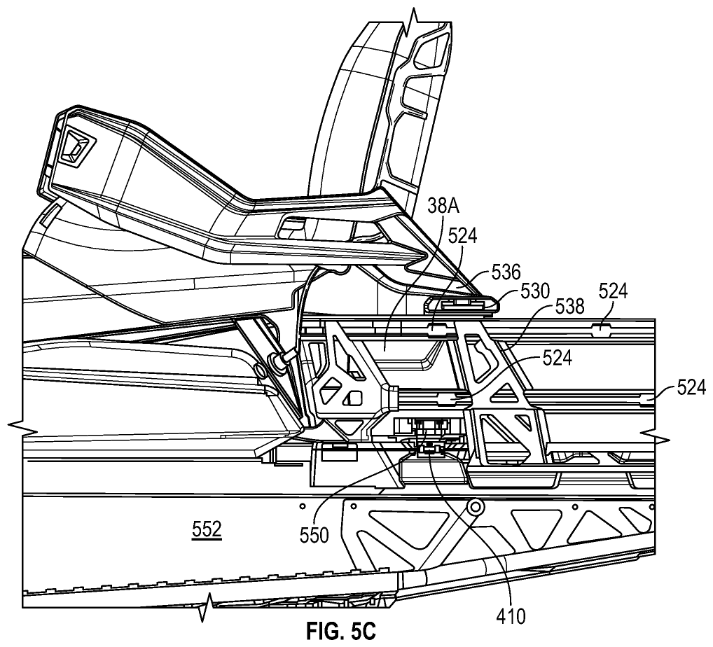

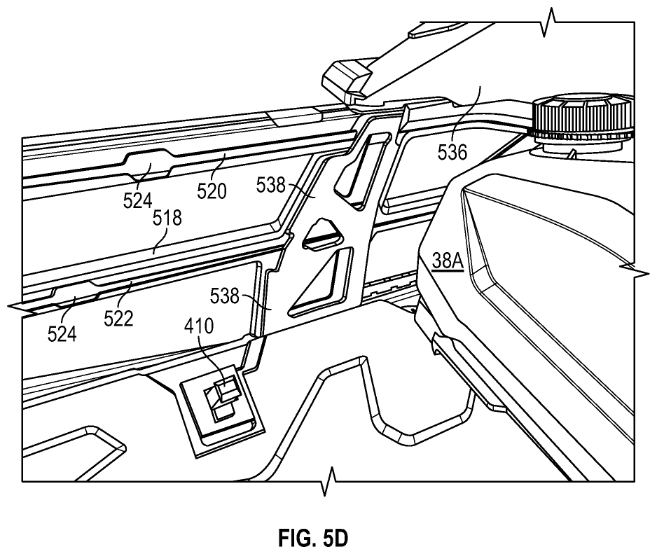

Referring now to FIGS. 5A-5D, the storage rack 68 is illustrated in further detail. The storage rack 68 is used to secure the passenger seat 36 and secure various accessories 38A, 38B and 38C. In FIGS. 5A and 5B, the accessories 38A are gas tanks. However, other types of accessories as mentioned above may be secured by the storage rack 68 on the rack platform 66. The pin housings 410 are located at six locations on the rack platform 66 to secure accessories thereto when needed. When not needed, the latch pin 430 may be inverted to be out of the way.

The storage rack 68, in this example, is secured to chassis at various securing locations 512 by at least one fastener 514. In this example, the passenger seat 36 is located behind the driver's seat 40.

The storage rack 68 is formed of a tubular structure in this example. An upper rail 516 extends around the perimeter of the rack. A lower rail 518 extends partially around the perimeter of the rack. In this example, the lower rail 518 does not extend across the rearward most portion of the storage rack 68. The upper rail 516 and the lower rail 518 may be formed of a tube and may be rectangular in cross-section.

The upper rail 516 has an upper surface 516A, an inner surface 516B and an outer surface 516C. Slots 520 are provided in the upper surface 516A, the inner surface 516B and the outer surface 516C.

The lower rail 518 has an upper surface 518A, an inner surface 518B and an outer surface 518C. Lower slots 522 are provided in the lower rail 518 and, in particular, the inner surface 518B of the lower rail 518 and the outer surface 518C of the lower rail 518.

The slots 520, 522 are used to secure accessories thereto. To facilitate the securing of the accessories, one or more of the slots 520, 522 may have an extended width portion 524 disposed therein. The extended width portions 524 may receive a fastener therein. The slots 520, 522 may be referred to as a T-slot. The inner portion of the slot is the top of the “T” while the space between the slots is the base of the T. In total there are 5 slots 520, 522: three upper and two lower in this example. In all, the rack 68 has a first slot, a second slot, a third slot, a fourth slot and a fifth slot that can be coupled to in a variety of ways to secure accessories.

Various accessories may be coupled to the storage rack 68 within the slots in a toolless manner. Various types of fasteners may be used in the slots therefore.

As mentioned above, the passenger seat 36 is secured to the storage rack 68. In particular, the passenger seat is secured to the slot 520 in the upper surface 516A of the upper rail 516 in toolless manner. A clamp 530 disposed on each side of the passenger seat 36 secures an arch 536 across the width of the storage rack 68. The arch 536 extends upward from the storage rack 68 to accommodate the accessory 38A.

The storage rack 68 may have upright members 538 that secure the upper rail 516 relative to the lower rail 518 and relative to the rack platform 66.

A clamp 550 that is part of or secured to the accessory 38 is used for securing the accessory 38A to the rack platform 566 at the pin housings 410. This is best illustrated in FIG. 5C.

The accessories 38A-38C may for example, be a fuel tank, an oil tank, a chain saw mount, a snowboard rack, an ice auger mount, a ski mount or a gun scabbard.

The arch 536 has a height above the rack and is tapered to allow insertion and removal of the accessory 38A without the removal of the passenger seat 36. The accessory 38A is located at least partially under the arch 536. In this example, the accessory 38A is located fully under the arch 536.

Portions of the slots 520, 522 run longitudinally. That is, the slots 520 on the upper surface 516A, the inner surface 516B and the outer surface 516C on the sides 552 run longitudinally whereas the slot 520 runs laterally at the rear portion 554 of the upper rail 516. The upper rail 516 and the lower rail 518 may be formed of various materials such as aluminum.

Referring now to FIGS. 6A-6f, the storage rack 68 may also be used for securing various accessory holders 610A coupled to the upper rail 516 and the lower rail 518 within the upper slot 520 and the lower slot 522. Fasteners 612 are used for securing the accessory holder 610A directly to slots 520, 522. In this example, the accessory holder 610 is a tool holder. As illustrated best in FIG. 6D, the tool is an axe 614. However, various types of handle tools may be accommodate within the accessory holder 610A. The accessory holder 610A is illustrated without the accessory holder 610B in FIG. 6C. The accessory holder 610A has a first mount 620 and a second mount 620E that are used for mounting the second accessory holder 610B thereto. The mounts 620A, 620B have fastener receivers 622A, 622B. In this example, the fastener receivers 622A are aligned with the slot 520. Fastener receivers 622B are aligned with the slot 522. This allows the accessory holder 610B to be fastened directly to the storage rack if the first accessory holder 610A is not provided.

The first accessory holder 610A has a pair of first portions 630 that are rotatably coupled to a pair of second portions 632 about a rotation pin 633. The first portion 630 and the second portion 632 may be joined by a fastening pin 636 that is received within openings 644 and opening 646 through the second portions 632. To close and secure the accessory holder 610A. The openings 646 are aligned with openings 644 by moving the second portions 632. The fastening pin 636 holds the first portion 630 together with the second portion 632 after it is inserted into the openings 644, 646. Fingers 638A extend inward from the first portions 630 and fingers 638B extend inward from the second portions 632. The fingers 638 extend inward and provide an opening 640 for receiving a tool or a tool handle. The fingers 638A, 638B may be compliant so that once underway, the tool, such as the axe 614, is secured in the opening and to the rack and vehicle.

The second accessory holder 610B, in this example, is a chain saw holder. The chain saw holder may have a blade holder 652 that is used for receiving the chain of the chain saw. A securing strap 654 is flexible and couples to the plates 650 for securing a chain saw in place. Of course, other kinds of accessory holders may be developed including ski holders, gun holders, specialty tool holders and holders for various types of implements. Fasteners 654A, 654B are used to align with the fastener receivers 622A, 622B, respectively. The fasteners 656A, 656B are thus aligned with the slots 520, 522. A second set of fasteners 656A, 656B are hidden in the various views but aligned with the fastener receivers 622A, 622B of the forwardmost mount 620 as illustrated in FIG. 6C.

In operation, the first accessory holder 610A may be secured to the rack 68 by securing the fasteners 612 in the slots 520, 522. Thereafter, the second accessory holder 610 may have the fasteners 656A, 656B secured within the fastener receivers 622A, 622B of the mount 620. The accessory holder 610A, 610B may then be used to secure the various tool or implement therein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A snow flap for a snowmobile comprising:
a first portion comprising a first material, said first portion comprising a first edge for mounting to the snowmobile and a second edge disposed opposite the first edge;
a second portion comprising a second material, said first material stiffer than the second material; and
a joint formed between the first portion and the second portion.

2. The snow flap of claim 1 wherein the first portion is co-molded with the second portion to form the joint.

3. The snow flap of claim 1 wherein the first portion extends rearward a predetermined angle from a of a tunnel.

4. The snow flap of claim 3 wherein the predetermined angle is about 30 degrees.

5. The snow flap of claim 1 wherein the second portion extends downward from the second edge in a first position.

6. The snow flap of claim 1 wherein the second portion may be folded and retained to the second portion in a second position.

7. The snow flap of claim 1 wherein the first portion comprises a first integrally molded retainer tab on a first longitudinal edge and a second integrally molded retainer tab on a second longitudinal edge.

8. A snowmobile comprising:
a chassis;
a flap mount coupled to the chassis, said flap mount comprising a laterally extending channel laterally receiving the snow flap of claim 1 therein.

9. The snowmobile of claim 8 wherein the laterally extending channel comprises a C-channel.

10. The snowmobile of claim 9 wherein the lower portion of the C-channel extends rearward more than an upper portion of the C-channel.

11. The snowmobile of claim 8 wherein the first edge comprises a retaining profile received within the laterally extending channel.

12. The snowmobile of claim 11 wherein the laterally extending channel comprises a first oval profile and the retaining profile comprises a second oval profile sized to be received within the first oval profile.

13. A rear light assembly for a vehicle comprising:
an elongated housing comprising a first portion at a first end, a second portion at a second end and a middle portion between the first end and the second end;
said first portion and the second portion comprising red light sources;
said middle portion comprising red light sources and white light sources; and
a light controller activates the red light sources in the first portion, the second portion and the middle portion as a brake light and taillight in a first mode and, in a second mode, activates the white light sources of the middle portion to illuminate and deactivating the red light sources of the middle portion.

14. The rear light assembly of claim 13 wherein the light controller deactivates the white light sources in the middle portion in the first mode.

15. The rear light assembly of claim 13 wherein the light controller comprises activating the red light sources in the first portion and the second portion as brake and taillights in the second mode.

16. The rear light assembly of claim 13 wherein the light controller activates the first mode or the second mode in response to a switch.

17. The rear light assembly of claim 13 wherein the light controller activates the first mode or the second mode in response to a gear sensor.

18. The rear light assembly of claim 13 wherein the light controller activates the first mode of the second mode in response to a speed signal from a speed sensor.

19. The rear light assembly of claim 13 wherein the light controller activates the first mode of the second mode in response to a location signal from a location module or a key position signal from a key switch.

20. The rear light assembly of claim 13 wherein the light controller comprises a user interface and a control module.

21. The rear light assembly of claim 13 wherein the light controller deactivates the white light sources in the second mode based on vehicle speed.

22. The rear light assembly of claim 13 wherein the first portion, the second portion and the middle portion are disposed on a unitary printed circuit board.

23. A locking pin assembly for an accessory comprising:
a housing comprising an upper portion a lower portion and a wall disposed between the upper portion and the lower portion, said upper portion having a volume thereunder, a pair spaced-apart slots disposed in the upper portion;
a latch pin comprising a base portion and a pin portion, said base portion having a first position and a second position within the slot, wherein in the first position the pin portion is disposed outward from the upper portion and in the second position the base portion is received in the slot so that the pin portion is disposed downward into the volume; and
a flexible finger coupled to the lower portion, said finger retaining the base portion in the slot in the first position and the second position.

24. The locking pin assembly of claim 23 wherein the finger is adjacent to the slot and deformable to be positioned below the slot.

25. The locking pin assembly of claim 23 wherein the slot is defined between an upper flange and a lower flange of the upper housing.

26. The locking pin assembly of claim 23 wherein the pin portion is rectangular in cross-section.

27. The locking pin assembly of claim 23 wherein the pin portion comprises a knob disposed thereon.

28. The locking pin assembly of claim 23 wherein the flexible finger comprises a first finger and a second finger, said first finger spaced apart from the first finger.

29. The locking pin assembly of claim 23 wherein the upper portion is formed into a rack platform.

30. A snowmobile comprising:
a chassis;
a primary seat for an operator of the snowmobile mounted to the chassis; and
a storage rack mounted to the chassis;
a passenger seat behind the primary seat; and
said storage rack having a first slot therein for securing the passenger seat thereto.

31. The snowmobile of claim 30 further comprising a first accessory mounted to the chassis behind the primary seat and beneath the passenger seat whereby the first accessory may be mounted and removed without removing the passenger seat.

32. The snowmobile of claim 30 wherein the passenger seat is toollessly mounted to the storage rack.

33. The snowmobile of claim 31 wherein the passenger seat has an arch thereunder, said arch sized to accommodate the first accessory.

34. The snowmobile of claim 33 wherein the arch is coupled to the first slot.

35. The snowmobile of claim 34 wherein the first slot is disposed on an upper surface of the storage rack and wherein the arch is coupled to the first slot on longitudinal slots.

36. The snowmobile of claim 33 further comprising a second accessory in cooperation with the first accessory, and mounted to the chassis behind the first accessory.

37. The snowmobile of claim 36 wherein the first accessory includes a first storage container, a first fuel tank, a first oil tank, a first chainsaw mount, a snowboard rack, an ice auger mount, a ski mount, or a gun scabbard.

38. The snowmobile of claim 37 wherein the second accessory includes a storage container, a secondary seat, a fuel tank, an oil tank, a chainsaw mount, a snowboard rack, an ice auger mount, a ski mount, or a gun scabbard.

39. The snowmobile of claim 36, wherein the first accessory is locked to first pin portions mounted to the chassis and the second accessory is locked to second pin portions mounted to the chassis.

40. The snowmobile of claim 39 wherein the first pin portions are reversibly locked to a rack platform of the chassis, and the second pin portions are reversibly locked to the rack platform of the chassis.

41. The snowmobile of claim 39 wherein the storage rack comprises an upper rail comprising the first slot on an upper surface.

42. The snowmobile of claim 41 wherein the upper rail comprises an inner surface comprising a second slot and an outer surface comprising a third slot.

43. The snowmobile of claim 42 wherein the storage rack comprises a lower rail having a second inner surface and a second outer surface, the upper rail spaced apart from the lower rail, said second inner surface comprising a fourth slot and said second outer surface comprising a fifth slot.

44. The snowmobile of claim 43 wherein the first slot, the second slot, the third slot, the fourth slot and the fifth slot comprise T-slots.

45. The snowmobile of claim 43 further comprising a first accessory holder coupled to the third slot and the fifth slot.

46. The snowmobile of claim 45 wherein the first accessory holder comprising a first mount and a second mount for coupling to a second accessory holder.

47. The snowmobile of claim 46 wherein a first pair of fastener receivers on the first mount are aligned with the third and fifth slot, respectively and wherein a second pair of fastener receivers on the second mount are aligned with the third and fifth slot, respectively.

48. The snowmobile of claim 41 further comprising an accessory rack.

49. The snowmobile of claim 41 wherein the upper rail and the lower rail comprise rectangular cross sections.
